(19) United States
(12) Patent Application Publication
(10) Pub. No.: US 2001/0047441 A1
(43) Pub. Date: Nov. 29, 2001

(54) Communications system conduit for transferring data

(76) Inventor: Mark Robertson, Pickering (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 09/789,573

(22) Filed: Feb. 22, 2001

Related U.S. Application Data
(60) Provisional application No. 60/184,344, filed on Feb. 23, 2000.

(51) Int. Cl. G06F 13/12; G06F 3/00; G06F 13/38

(52) U.S. Cl. 710/65

(57) ABSTRACT

A communications system conduit for transferring data between various user hand held devices and a processing device comprises an interface module, a data conversion module and a plurality of access ports. The interface module of conduit comprises a USB hub which provides data in USB format to a plurality of data converters residing within data conversion module. The output of the various data converters are provided as access ports. The conduit and the processing device are integrated to form a Web-based multi-media kiosk designed for use as a “virtual sales agent” within retail shopping environments. The individual data converters convert a data stream from USB format into various data formats including FireWire IEEE 1394, USB, Bluetooth, Infrared, Ethernet RJ45, RJ11 Telephone standard, and RS232 data formats. The user is provided with multimedia menu screens to allow the user to select data transfer for a particular hand held device.

### FIELD OF THE INVENTION

This invention relates to the field of data storage and data communication, and in particular relates to a multi-platform communication system conduit for downloading and uploading data to and from a wide variety of end user devices.

### BACKGROUND OF THE INVENTION

Conventionally known stand alone kiosk-based information systems provide users with Internet access and an ecommerce facility. Kiosk-based information systems are available at a variety of locations including airports, shopping malls and hotels and are designed to be used by the average end user who has little or no experience with computer or information systems. Accordingly, kiosk interfaces generally provide the end user with easy to use controls, information display and downloading capabilities. User friendliness is a critical factor in providing mass market kiosk systems for average consumer use.

Several types of mobile hand held devices are currently commercially available, including computer laptops, cell phones, digital cameras, video camcorders, Personal Digital Assistant (PDA), and other multimedia peripherals. All of these hand held devices are manufactured with specific data input and output interfaces for data communication (e.g. RJ11 telephone jack for modem communication, infrared transceiver for infrared signal communication etc.) and accordingly fall into different device platform categories.

The recent introduction of PDA devices has enabled end users to use small, relatively inexpensive, and portable computer devices which utilize software which is specifically written for tasks a user might expect to perform while travelling. Apple Computer, Hewlett Packard, IBM Corp., and several other well-known computer manufacturers have made a considerable investment in the development and promotion of PDA devices. PDA devices are provided with the facility to effect data communication by modem, by infrared communication as well as by serial connection. It is also contemplated that PDA devices will shortly be equipped with the facility to communicate using the BlueTooth™ radio frequency standard which allows for longer range data communication within a personal area network (PAN).

Existing stand alone kiosks do not provide end users with the ability to downloaded and upload data to and from a variety of commercially available external user devices such as PDA's (e.g. the PalmPilot™) and laptop computers. As increasing types of hand held devices are developed and as end users increasingly use such hand held devices in the course of their daily activities, the ability to provide cross-platform data communication will enable end users to take full advantage of the accompanying rise in hand held device processing power and provide to end users with additional convenience for routine daily tasks.

Accordingly, there is a need for an inexpensive and flexible communication system conduit which transfers data between a processing device and a plurality of end user hand held devices and which provides cross-platform capabilities for a wide range of internet kiosks and touch screen systems.

### SUMMARY OF THE PRESENT INVENTION

It is therefore an object of the present invention, to provide a communication system conduit for transmitting data between a processing device and a user device, said conduit comprising:

(a) an interface module operatively coupled to the processing device for receiving and transmitting data in a first data format;

(b) a data conversion module operatively coupled to said interface module for converting data between said first data format and a second data format; and

(c) a plurality of access ports coupled to said data conversion module for receiving and transmitting data in said second data format.

In another aspect the invention provides a method of transmitting data from a processing device to a user device, said method comprising the steps of:

(a) receiving data from the processing device in a first data format;

(b) converting said data from said first data format to a second data format; and

(c) receiving data in said second data format from said user device and transmitting data in second data format to said user device.

In another aspect the invention provides a method of transferring data between a user device and a processing device, said method comprising the steps of:

(a) receiving data from the user device in a first data format;

(b) converting said data between said first data format and a second data format; and

(c) transmitting data in said second data format from said user device to said processing device.

### BRIEF DESCRIPTION OF THE DRAWINGS

For a better understanding of the present invention and to show more clearly how it may be carried into effect, reference will now be made, by way of example, to the accompanying drawings, which show a preferred embodiment of the present invention and in which:

FIG. 1 is a block diagram of the general system architecture that includes the communications system conduit of the present invention;

FIG. 2 is a schematic diagram of one embodiment of the conduit of FIG. 1;

FIG. 3 is a flow chart showing the steps executed by the processing device to install the conduit within the kiosk of FIG. 1;

FIG. 4 is a screen capture of a sample menu screen which is provided to the administrator when installing the conduit within the kiosk of FIG. 1;

FIG. 5 is a flow chart showing the general operation steps which are executed by the processing device to operate the kiosk shown in FIG. 1;

FIG. 6 is a flow chart showing the steps which are executed by the processing device in response to user instructions;

FIG. 7 is a screen capture of the kiosk display showing a sample user menu screen which is used to obtain instructions from an user; and

FIG. 8 is a picture of the external shell of the conduit of FIG. 1.

### DESCRIPTION OF THE PREFERRED EMBODIMENT

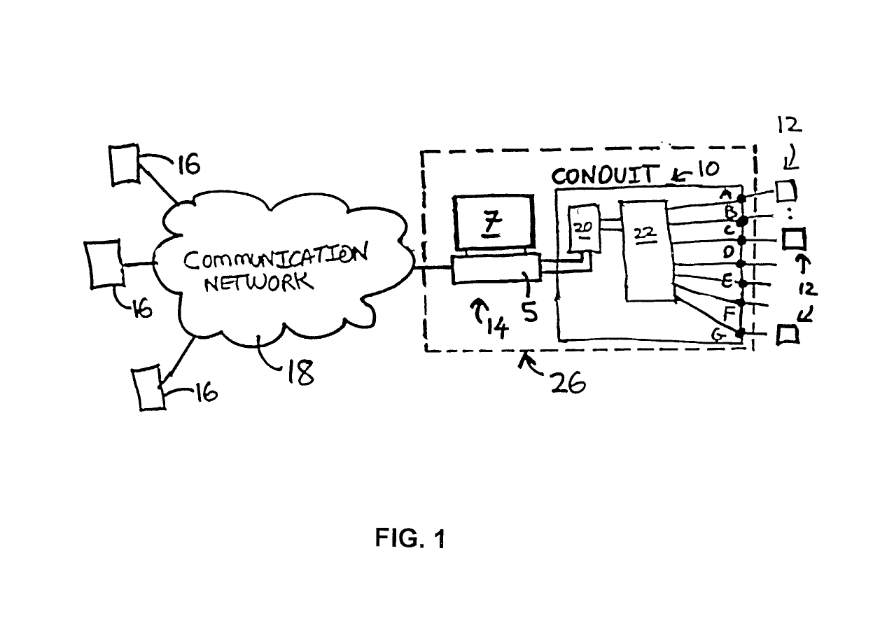

Reference is first made to FIG. 1 which shows a general system architecture for an internet-based kiosk system which utilizes communication system conduit 10 made in accordance with a preferred embodiment of the invention. Conduit 10 serves as an data interface between a plurality of user peripheral devices 12 and a processing device 14 which in turn is coupled to external data nodes 16 through a communications network 18 (e.g. the Internet). Conduit 10 comprises an interface module 20, a data conversion module 22 and a plurality of access ports A to G. The operation of these components are controlled by software installed on processing device 14, as will be discussed.

Processing device 14 is preferably a conventional personal computer having a central processing unit (CPU) 5 and display 7 with a fully supported USB of other high speed, standard data interface. Processing device 14 receives and transmits data to and from external data nodes 16 through communication network 18. Accordingly, processing device 14 serves as an intermediary between said external data nodes 16 and said conduit 10.

Interface module 20 is coupled to processing device 14 and receives and transmits a data stream from processing device 14. Interface module 20 provides the data stream received from processing device 14 to data conversion module 22. Preferably, the data stream received and transmitted by interface module 20 is either in USB or FireWire data format, although it should be understood that conduit 10 could be utilized to receive and transmit a data stream from processing device 14 in any other conventional data format.

Data conversion module 22 converts the data format of the data stream between USB format and a number of conventionally known data formats (e.g. RS232, FireWire, Bluetooth, etc.) Processing device 14 contains a software program (not shown) which provides the user with a series of machine executable query screens on display 7, which allows the user to choose the particular data format that is required by their peripheral device 12, as will be described.

Access ports A to G are operatively coupled to data conversion module 22 and are adapted to communicate data to a plurality of corresponding peripheral devices 12. Peripheral device 12 can be any commercially available hand held computing device, including personal digital assistants (PDA's) (e.g. the PalmPilot™ available from 3 Comm Inc., the Newton™ available from Apple Computers), laptop computers, as well as any other currently emerging data receiver units (e.g. the OEB compliant eBook or any other hand held device capable of receiving and/or transmitting data for storage or processing).

Conduit 10 and processing device 14 are integrated together to form a multi-media kiosk 26 designed for use as a “virtual sales agent” within retail shopping environments. It should be understood that display 7 of processing device 14 could either be a touch screen input device for kiosk 26 or a separate touch screen and/or multimedia input device could be integrated with processing device 14 and installed within kiosk 26 to provide a desired multimedia interface with the user.

The preferred embodiment of the present invention utilizes the Internet as communication network 18. The Internet provides a low-cost efficient manner of distributing various types of multimedia content to and from content providers as well as for distribution of general advertising, marketing and sales information. Those skilled in the art will recognize that any communication network 18 utilizing any communication protocol may be used to practice the present invention.

Also, while the preferred embodiment utilizes seven access ports A to G, this does not preclude the addition of new access ports as new hardware connections and communication protocols are created. Similarly, given the rapid change in the computer industry it is possible that the connections illustrated herein may no longer be useful and may be deleted.

Security is provided by “firewall” technology installed on processing device 14 (as conventionally known), thus significantly reducing the potential for security breaches. Further, security may be provided over the Internet by encrypting the transmissions to ensure any intercepted message is virtually indecipherable as well as by utilizing biometric methods (e.g. iris scan) for identifying users by providing the appropriate biometric interface (not shown) within kiosk 26, as is conventionally known.

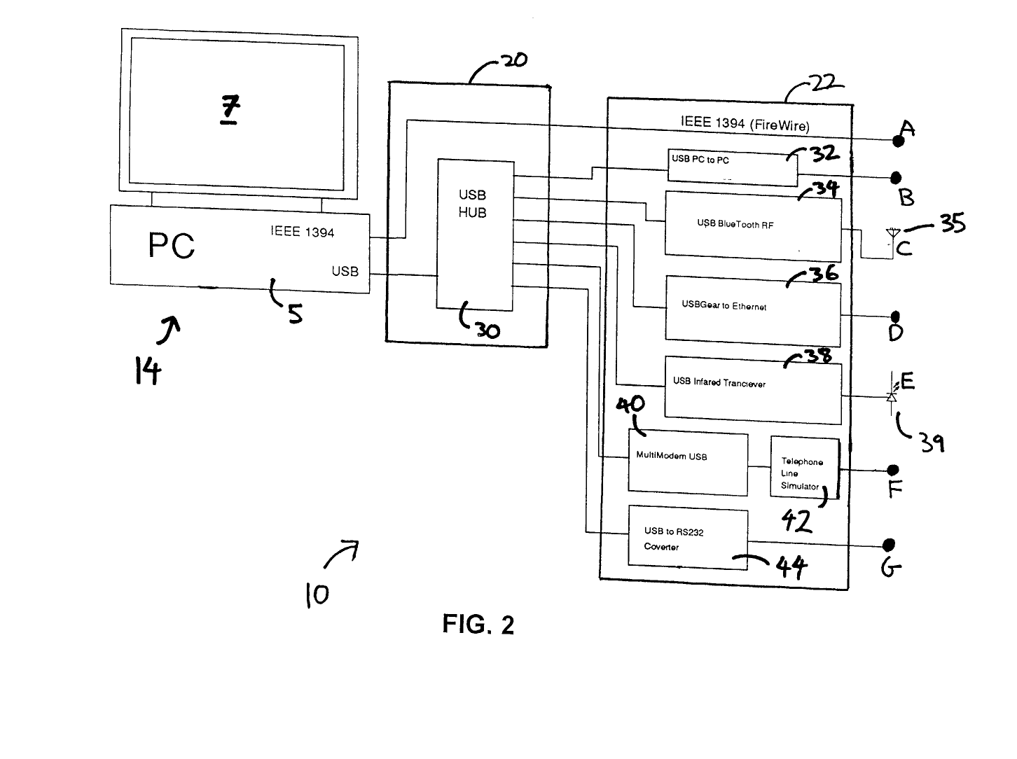

FIG. 2 shows a more detailed view of the data processing components of processing device 14 and conduit 10. Processing device 14 can be realized by any computing system employing operating system (OS) software (e.g. the Windows 98 and Windows 2000 operating systems, etc.) which supports the USB standard, which supports an Internet browser program (e.g. Netscape Navigator, Microsoft Internet Explorer, etc.) and which includes an Internet networking software that supports the TCP/IP networking protocol (required by HTTP, FTP and the like).

The interface module 20 comprises a conventional Universal Serial Bus (USB) hub 30 which can be used to provide a plurality of data streams for input into the individual conversion devices of data conversion module 22. The USB standard is based on a particular architecture and protocol defined in a specification published as Specification Version 1.0 on Jan. 15, 1996 by Compaq, DEC, IBM, Intel, Microsoft and Northern Telecom. The USB enables “plug and play” attachment of one or a number of “devices” for data flow. Specifically, USB hub 30 can be implemented using the seven-port Uni-Bus™ USB Hub (available from Hobbes) which provides seven downstream ports. USB hub 30 provides each downstream port with over current protection per port and a 500 milliampere power output and can detect high speed (12 Mbps) and low speed (1.5 Mbps) devices and connections.

Interface module 20 also consists of a FireWire (i.e. the IEEE-1394 High Performance Serial Bus standard) connection which is provided directly from processing device 14 (e.g. Power Macintosh G3 computers and compatible IBM computers) to access port A (i.e. FireWire modular jack) through data conversion module 22. As is conventionally known, the FireWire standard operates at speeds up to 400 Mbps and is ideal for higher-speed multimedia peripherals (e.g. video camcorders, music synthesizers, and photographic storage devices etc.) and allows for the transmission of broadcast-quality video.

Data conversion module 22 comprises a series of commercially available data converters 32, 34, 36, 38, (40 and 42) and 44 which convert data from a USB data format into a number of other conventional data formats, as will be described. All of the individual data converters are “hot pluggable”, that is they are USB devices which can be plugged in and removed from processing device 14 without having to reset processing device 14. Also, since all of these data converters are USB devices, external power sources are not required.

Specifically, a USB to USB converter 32 is used to convert data in the USB data format from interface module 20 to data in the USB data format at access port B for downloads and uploads between processing device 14 and a laptop computer device 12. PC to PC data converter 32 can be implemented using a USBGear™ PC to PC LINK (manufactured by USBGear) which has a transfer rate of up to 8 Mbps and which is compatible with USB Specification 1.1.

A USB BlueTooth RF converter 34 is used to convert between USB format data from interface module 20 to BlueTooth format data at access port C. A BlueTooth R/F proximity reader and transmitter unit 35 is built into the casing of conduit 10 and allows for downloads and uploads between processing device 14 and a RF enabled peripheral device 12 (e.g. a PDA which has a BlueTooth transceiver device installed within). BlueTooth wireless technology is a de facto standard (current version 1.03) and specification which has been developed by the BlueTooth Special Interest Group (SIG) (i.e. companies such as Ericsson, IBM Corporation, Intel Corp., Microsoft Corp.) for low-cost, short range radio links between mobile personal computers, mobile phones, and other portable devices at speeds up to 1 Gbps. BlueTooth technology operates in the 2.4 GHz range (e.g. within the UHF band) and uses frequency hopping spread spectrum techniques to resist signal interference and fading.

A USB Ethernet converter 36 is used to convert USB format data to data in the Ethernet data format at access port D (i.e. a RJ45 network jack) for downloads and uploads between processing device 14 and an Ethernetbased peripheral device 12 (e.g. a laptop with an Ethernet port). USB Ethernet converter 36 can be implemented by the USBG-110T USB Ethernet Adapter (manufactured by USBGear) which provides connection between a USB-enabled personal computer and a 10/10BaseT Ethernet LAN which typically operates at speeds up to 100 Mbps.

A USB Infrared Transceiver 38 is used to convert USB format data to Infrared data for downloads and uploads between processing device 14 and an Infrared-based peripheral device 12 (e.g. a PDA with a built-in infrared transceiver) at access port E. An infrared transceiver 39 is built into the housing of conduit 10 for transmitting and receiving data from an Infrared-based peripheral device 12. As conventionally known, infrared communication links modulate a focused ray of light in the infrared frequency spectrum (i.e. in the terahertz range) with information and transmit the modulated light ray over a relatively short distance (e.g. from a remote control to a television) from access port E. USB Infrared Transceiver 38 can be implemented by the ACT-IR2000U IrDA USB adaptor which converts USB data into Infrared signals allowing high speed 4 Mbps wireless data transfer.

A USB telephone line converter 40, 42 is used to convert USB format data into conventional data modulated in a dial-up telephone signal for downloads and uploads between processing device 14 and a modem equipped peripheral device 12 (e.g. a laptop with a conventional telephone modem) at access port F (i.e. conventional RJ11 phone jack). Specifically, USB telephone line converter 40, 42 can be implemented using a Viking™ 56 K V.90 USB multi-modem and a Viking™ DLE-200B Telephone Line Simulator (manufactured by Viking Electronics). The V.90 USB multi-modem signals at 14.4 KHz with industry-standard error correction and data compression. The DLE-200B line simulator provides two way communication between the multi-modem and a peripheral device 12 installed at access port F.

A USB RS232 converter 44 is used to convert USB format data into conventional RS232 data for downloads and uploads between processing device 14 and a RS232 serial peripheral device 12 (modem, digital camera, etc.) at access port G. USB RS232 converter 44 can be implemented by USC-100 USB to Serial convert cable (manufactured by Hobbes) which allows processing device 14 to use any serial device through the cable.

It should be noted that the FireWire IEEE-1394 standard requires that peripheral devices 12 be connected to the FireWire cable at a distance of less than 4.5 meters of the bus socket (before signal attenuation begins to occur) so it would be recommended that conduit 10 provide access port A within this distance from processing device 14. However, as is conventionally known, it would also be possible to connect up to 16 devices in a single chain, each having the 4.5 meter maximum. Therefore, it would be possible to provide additional FireWire ports within conduit 10 to have access port A up to 72 meters away from processing device 14.

With respect to the BlueTooth RF signals which are transmitted at access port C, it is contemplated that a user would be able to walk by with a device which effects a personal area network (PAN) (e.g. a briefcase containing a RF transceiver-based PDA) which would communicate with processing device 14 through the BlueTooth transceiver 34 at access port C to effect the wireless transfer of books, newspaper and other data from kiosk 26 to the user's device. With the advent of PANs, it is contemplated that users will be accustomed to receiving data communication (e.g. to download newspaper information and to provide wireless payment from user) between their PDA's and data downloading stations, such as kiosk 26 simply by walking past the downloading station. As is conventionally known, radio frequency communication allows for data communication while peripheral device 12 is within 50 meters of kiosk 26. This allows user to receive and/or transmit a substantial amount of data while walking towards and walking away from kiosk 26.

Also, with respect to the Infrared data signals which are received and transmitted at access port E, a user must be careful to position peripheral device 12 relatively close to access port E in order to effect successful data transfer. It is contemplated that kiosk 26 would be adapted to provide a recess or cradle (not shown) within its housing in close proximity to access port E within which the user may rest peripheral device 12 for optimal data transfer. Infrared access port E provides kiosk 26 with the ability to provide data communication to commercially available PDAs (e.g. Psion™, PalmPilot™, Newton™, etc.)

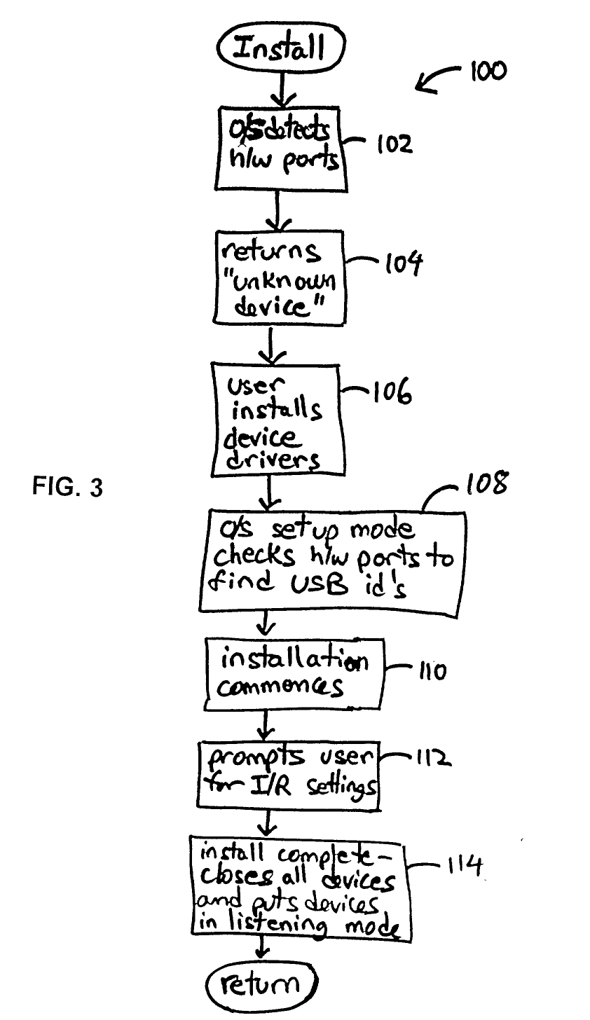

FIG. 3 shows a flowchart of installation process steps (100) which are executed by processing device 14 to configure conduit 10 within kiosk 26 (FIG. 1). These process-steps are executed by an installation program running on processing device 14 under the control of a system administrator. It should be understood that all of the data conversion devices of data conversion module 22 as well as the USB hub 30 of interface module 22 are controlled by device drivers which are installed within the operating system of programming device 14, as is conventionally known. Each device driver contains the special knowledge of the individual data converters (e.g. the USB Infrared transceiver 38) of data conversion module 22, discussed above. The required device drivers may already exist on processing device 14 or the system administrator may install them from a portable medium such as a floppy disk or CD ROM.

Once processing device 14 and conduit 10 have been powered up with the main installation disk inserted in processing device 14, the operating system (O/S) of processing device 14 will initially detect the various hardware ports of conduit 10 at step (102) and will return the message “unknown device” at step (104). At that point, the installation software will prompt the system administrator of kiosk 26 to install the device drivers associated with the data converters of data conversion module 22 at step (106). The installing software then prompts the O/S to enter its set up mode and check access ports A to G to check all associated USB identifiers at step (108). If any of the device drivers are not installed on processing device 14, then they will be installed on processing device 14 from the system administrator's installation disk at step (110).

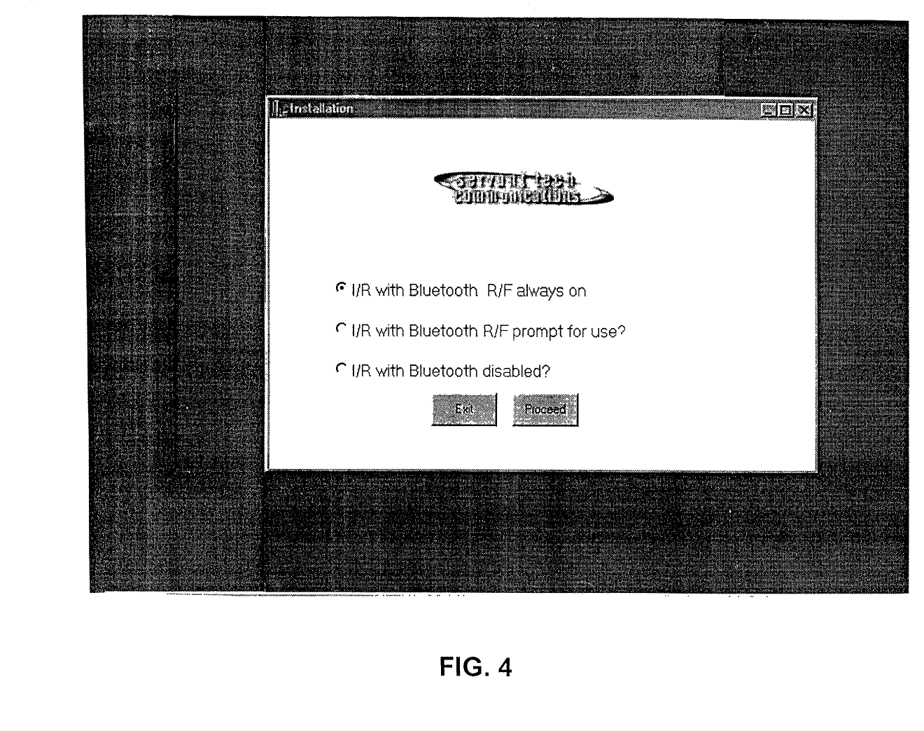

Next, as shown in FIGS. 3 and 4, the O/S prompts the system administrator at step (112) for settings that relate to the specific operation of the BlueTooth and Infrared access ports C and E. Since there is the possibility of a certain amount of signal interference between the BlueTooth and the Infrared transmissions from conduit 10, the system administrator must decide how they would like to regulate the activity of access ports C and E.

As shown in the sample system administrator setup menu of FIG. 4, the system administrator can decide whether to have continuous BlueTooth receiving and transmission at access port C (i.e. automatically convert an incoming data stream between BlueTooth data format and USB data format regardless of what other formats have been selected), whether BlueTooth conversion should require a user's prompt for use, or whether BlueTooth conversion should be disabled. It is contemplated that signal interference issues associated with the use of BlueTooth RF and Infrared facilities within conduit 10 can be resolved using conventionally known signal timing and shielding techniques.

Finally, processing device 14 completes the installation and configuration of conduit 10, closes all data conversion devices of data conversion module 22 and puts them in a conventional “listening mode” at step (114) to await activation by processing device 14.

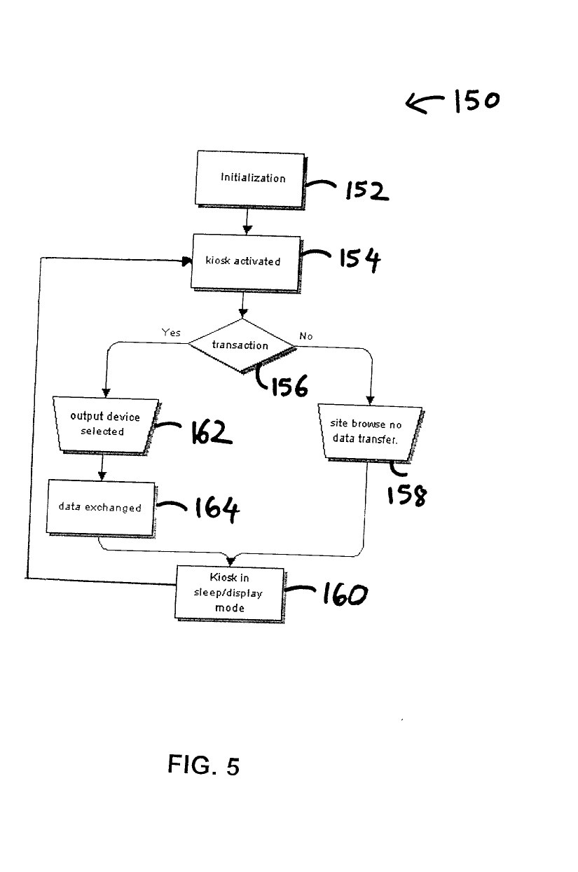

FIG. 5 shows a flowchart of high level operational process steps at step (150) which are executed by processing device 14 to control the operation of kiosk 26 (FIG. 1).

Referring now to FIGS. 1, 2 and 5, when kiosk 26 is turned on (after the installation of conduit 10 as discussed above has been completed), processing device 14 performs initialization at step (152) of kiosk 26 and places kiosk 26 into a “listening mode”. User activates kiosk 26 at step (154) by touching the touch screen input (e.g. display 7 of processing device 14) or some other conventional activation activity (e.g. walking by kiosk 26 while providing the appropriate BlueTooth RF signalling that a data download is requested). Kiosk 26 will then determine whether a data communication transaction has been requested by the user at step (156). If not, processing device 14 will then simply allow user to browse the stored information stored in the CPU 5 as the user interacts with the multimedia interface of kiosk 26 as is conventionally known at step (158). Once the user has finished browsing and kiosk 26 has been inactive for a predetermined period of time, kiosk 26 will enter a standard sleep/display mode at step (160) and await initiation activity from user.

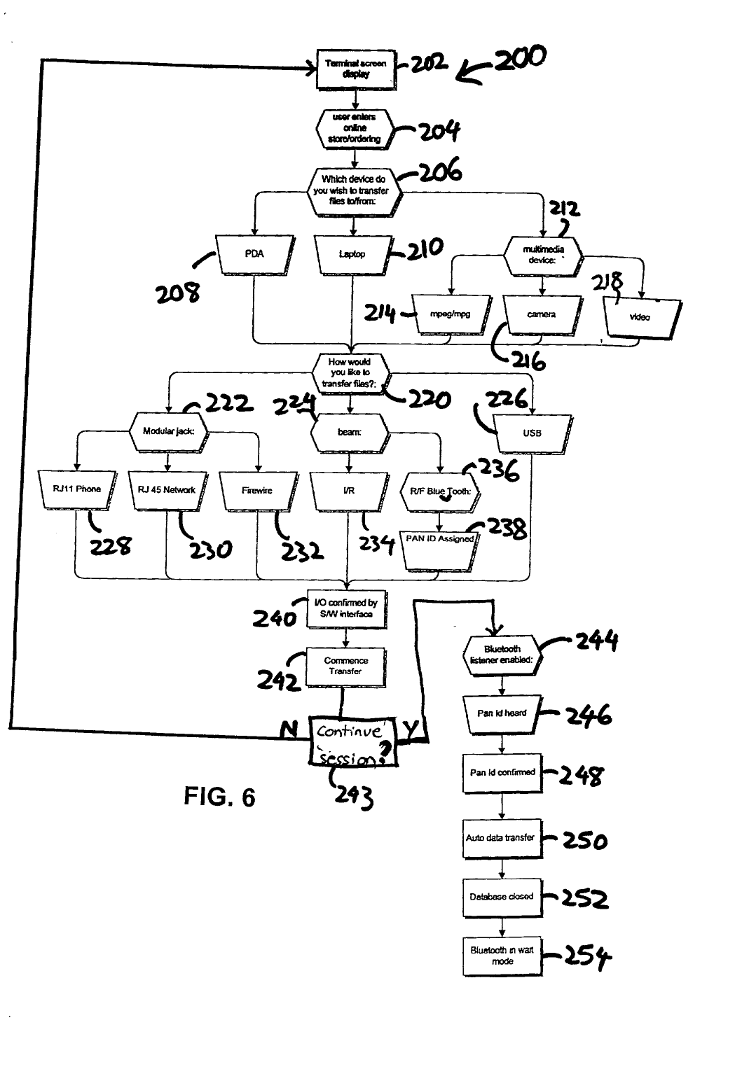

If a data communication transaction has been requested by the user, then processing device 14 will query the user as to which data format is desired (i.e. by executing a device selection routine as will be discussed in relation to FIG. 6) and will select the appropriate data conversion device at step (162). Once the appropriate data conversion device has been chosen within data conversion module 22, data will be exchanged between kiosk 26 and the user at step (164). After the data transfer is complete, kiosk 26 will enter the standard sleep/display mode at step (160) and await further user interaction.

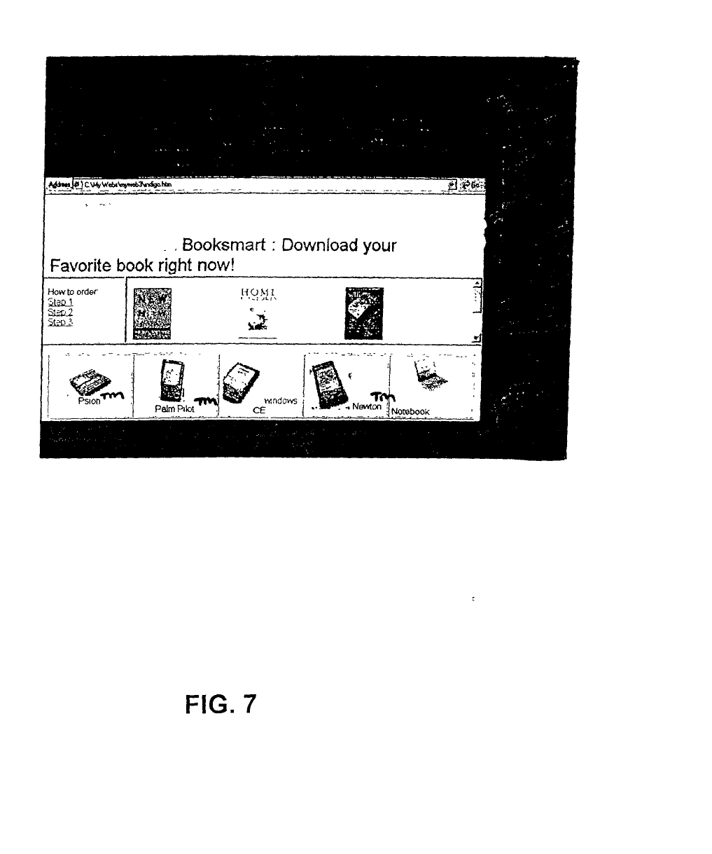

FIG. 6 shows a flowchart of specific operational process steps at step (200) which are executed by processing device 14 to control the operation of interface module 20, data conversion module 22, and access ports A to G (FIG. 1). While inactive, kiosk 26 displays the standard terminal screen display (e.g. standard browsing menu screens) at step (202) until the user initiates a data communication transaction with kiosk 26. Once a data transaction has been initiated and the user enters online order at step (204), kiosk will respond with an initial menu asking the user to choose the type of peripheral device 12 that they are using at step (206). FIG. 7 shows a sample user menu screen which prompts the user to chose the appropriate peripheral device 12 for data communication (i.e. data download or upload). As shown, the user may choose a number of options, namely PDA at step (208), laptop at step (210) and a multimedia device at step (212), being either a MPEG/MPG device at step (214), camera at step (216), or video at step (218) (FIG. 7).

Once the user has selected the type of device that they wish to conduct the data transfer with, they are presented with another menu (not shown) which instructs them to choose a particular data format (i.e. since some devices have multi-format capabilities), namely either modular jack at step (222), signal beam at step (224) and USB at step (226). As the user selects the particular type of physical interface, processing device 14 enables the appropriate data converter device within data conversion module 22 using the associated device driver.

Specifically, if the user selects the RJ11 phone jack then processing device 14 activates multimodem USB 40 and telephone line simulator 42 at at step (228). If the user selects the RJ45 network jack then processing device 14 activates USB to Ethernet converter 34 at at step (230).

If the user selects FireWire jack then processing device 14 will activate data transfer in FireWire format which flows directly through interface module 20 and data conversion module 22 to access port A, as previously discussed. If the user selects Infrared beam, then processing device 14 will activate USB Infrared transceiver 38 at step (234). If the user selects RIF BlueTooth beam, then processing device 14 will activate USB BlueTooth transceiver 34 if necessary at step (236) (according to the preset BlueTooth/IR settings discussed above) and assign a specific PAN identifier to the user at step (238).

Once processing device 14 has completed the physical setup of the data conversion module 22 for data transfer, processing device 14 confirms whether there is to be data transmission or receipt to/from user at step (240) and commences data transfer at step (242). It should be noted that for all other data transfers except BlueTooth data, data transfer is completed at this step. For data transfers other than BlueTooth data processing device 14 will determine when data transfer is complete and if so will decide not to continue session at step (243).

In the case of a BlueTooth data communication, processing device 14 will not actually transfer any data during step at step (242) and instead will decide to continue session at step (243) into the specific BlueTooth routine shown. Processing device 14 will enable the BlueTooth listener at step (244) (i.e. put BlueTooth transceiver in receiver mode to identify user) and once the user's PAN identifier is heard at step (246), processing device 14 will confirm the PAN identifier at step (248). Once the PAN identifier has been confirmed then processing device will initiate the automatic data transfer (either download or upload) between processing device 14 and peripheral device 12 at step (250) (e.g. the download of a newspaper into a PDA and the payment by wireless funds transfer). Once data transfer is complete then processing device 14 will close the PAN identifier database at step (252) and put the BlueTooth transceiver 39 back into “wait mode” at step (254).

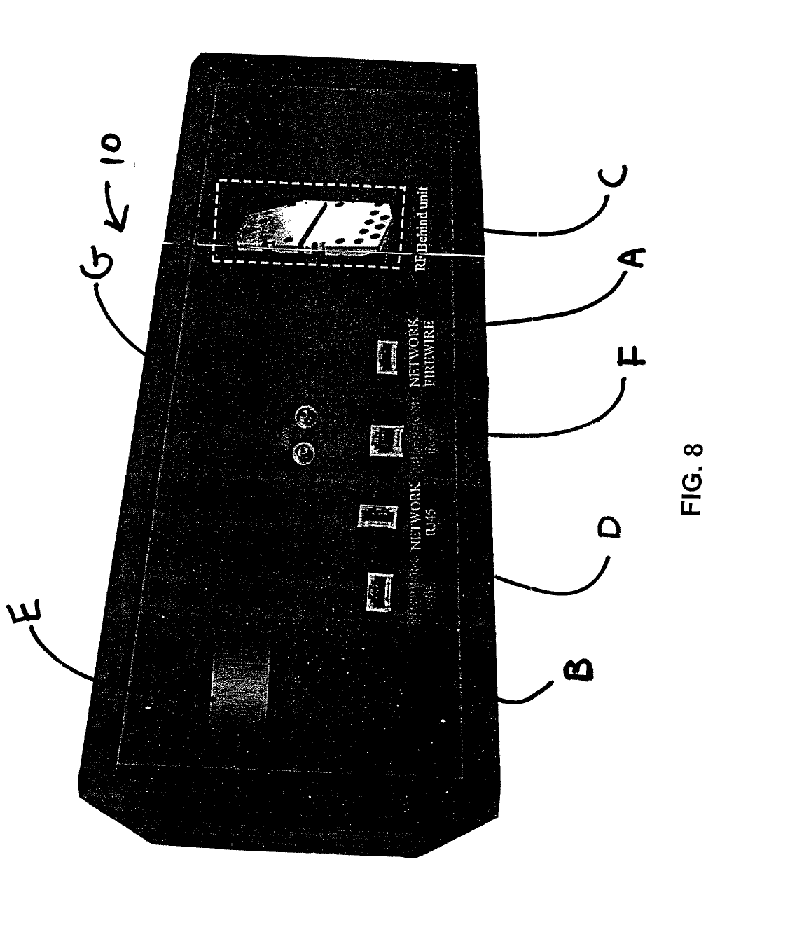

FIG. 8 shows a pictorial representation of the outer casing of conduit 10 and the various access ports A to G as discussed above. It should be understood that conduit 10 could incorporate other types of data converters within data conversion module 22 for additional data transfer functionality. It is contemplated that as new data communication standards progress, additional data formats will be introduced and may be accommodated by conduit 10. Further, conduit 10 may also be used in association with additional computer hardware, such as a card reader or various biometric security devices within kiosk 26, as is conventionally known.

Conduit 10 allows users to perform a wireless data transfer of books, newspapers, and literature and other documents including text and images to and from hand held devices as well as the transfer of MPEG, MPG, Real Audio and Real Video, music and multimedia files to Infrared or USB enabled multimedia players/recorders as well as serial/parallel and cradle devices. Conduit 10 can accommodate both streaming (i.e. real time multimedia data transfer) and nonstreaming type of data transfers between processing device 14 and user.

It should also be understood that conduit 10 can be utilized in association with various commercially available computing platforms (e.g. Macintosh, PC, Unix) for use within a wide range of floor and wall mounted Internet kiosks and touch screen systems. Also, it should be understood that while it is preferable for conduit 10 to be integrated with processing device 14 into a stand alone kiosk 26, it would also be possible for conduit 10 to be integrated into other types of user devices such as set top boxes and desktop computer workstations. Finally, it should be understood that while access ports A to G are shown, it would be possible for conduit 10 to provide data conversion for any practical number and types of known data formats.

Also, while the present invention has been discussed in terms of downloading data from processing device 14 to peripheral devices 12, it should be understood that conduit 10 is a two-way communication device, and accordingly that data may also be uploaded to peripheral devices 12 as long as the user can identify themselves (e.g. using a biometric indicator, user card or PIN number) to kiosk 26 for security and identification purposes. For example, a user may wish to upload digital image data from a video recorder. By attending at kiosk 26, providing suitable user identification and choosing the specific data format which is to be used for the data transfer, digital image data may be uploaded from the user's video recorder through the appropriate access port, into data conversion module 22, interface module 20 and into processing device 14. From there, processing device 14 can forward the image data over communication network 18 to a external node 16 via file transfer protocol (FTP).

Conduit 10 may also be used in association with processing devices 14 which are connected to internal organizational networks (i.e. as a network gateway) to provide a variety of conventional business related services, such as employee monitoring, plug and play video conferencing between employees, alarm systems and automation, receiving and sending faxes. Conduit 10 may also be used in association with Internet-based resources to provide a wide variety of Internet related services, such as online stock trading, telemedicine and the like.

Due to the ability of conduit 10 to provide data transfer between kiosk 26 and a wide variety of hand held devices, the web-based kiosk 26 will be able to provide cross-platform data transferring services to the average users in a variety of conventional commercial and non-commercial locations, such as supermarkets, department stores, superstores, home centres, discount retail outlets, libraries, community centres, schools, tourist bureaus, etc. Also due to the compact nature of conduit 10, it is possible to provide a wall mounted version of kiosk 26 for commercial use or for internal organization use (e.g. as a network gateway). Also, it should be appreciated that Infrared data communication could be adopted in environments which are not suitable for radio frequency transmissions (i.e. hospitals).

As will be apparent to those skilled in the art, various modifications and adaptations of the method and system described above are possible without departing from the present invention, the scope of which is defined in the appended claims.

I claim:

1. A communication system conduit for transmitting data between a processing device and a user device, said conduit comprising:
(a) an interface module operatively coupled to the processing device for receiving and transmitting data in a first data format;
(b) a data conversion module operatively coupled to said interface module for converting data between said first data format and a second data format; and
(c) a plurality of access ports coupled to said data conversion module for receiving and transmitting data in said second data format.

2. The conduit of claim 1; wherein said data conversion module comprises a plurality of data converters selected from the group consisting of USB to FireWire, USB to USB, USB to Bluetooth, USB to Ethernet, USB to Infrared, USB to telephone, and USB to RS232 data converters.

3. The conduit of claim 2, wherein said conduit further comprises a user input means, said user input means being configured to allow a user to select one of the data converters.

4. The conduit of claim 1, wherein said processing device is operatively coupled to a communications network for transmitting and receiving data over said communications network.

5. The conduit of claim 1, wherein said first data format comprises the USB data standard.

6. The conduit of claim 1, wherein said first data format comprises the FireWire data standard.

7. A method of transmitting data from a processing device to a user device, said method comprising the steps of:
(a) receiving data from the processing device in a first data format;
(b) converting said data from said first data format to a second data format; and
(c) receiving data in said second data format from said user device and transmitting data in second data format to said user device.

8. The method of claim 7, wherein said second data format is selected from the group consisting of FireWire, USB, Bluetooth, Ethernet, Infrared, telephone standard, and RS232 data formats.

9. The method of claim 7, wherein said data comprises the contents of a book.

10. The method of claim 7, wherein said data comprises the contents of a periodical.

11. The method of claim 7, wherein said data comprises a collection of music.

12. The method of claim 7, wherein said data comprises financial transactional data.

13. A method of transferring data between a user device and a processing device, said method comprising the steps of:
(a) receiving data from the user device in a first data format;
(b) converting said data between said first data format and a second data format; and
(c) transmitting data in said second data format from said user device to said processing device.

14. The method of claim 13, wherein said first data format is selected from the group consisting of FireWire, USB, Bluetooth, Ethernet, Infrared, telephone standard, and RS232 data formats.

15. The method of claim 13, wherein said second data format is selected from the group consisting of FireWire and USB.

16. The method of claim 13, wherein said first data format comprises the USB data standard.

17. The method of claim 13, wherein said first data format comprises the FireWire data standard.
